(19) United States
(12) Patent Application Publication
(10) Pub. No.: US 2010/0257089 A1
(43) Pub. Date: Oct. 7, 2010

(54) Intellectual Property Pre-Market Engine (IPPME)

(76) Inventor: Apperson H. Johnson, Wilmington, DE (US)

Correspondence Address: Apperson H. Johnson, 29 Paxon Dr., Wilmington, DE, 19803, US

(21) Appl. No.: 12/754,605

(22) Filed: Apr. 5, 2010

Related U.S. Application Data
(60) Provisional application No. 61/166,752, filed on Apr. 5, 2009.

(51) Int. Cl. G06Q 99/00; G06Q 40/00; G06Q 50/00

(52) U.S. Cl. 705/37; 705/310

(57) ABSTRACT

The present invention, known as the Intellectual Property Pre-Market Engine (IPPME) relates generally to the field of automated entity, data processing, system control, and data communications, and more specifically to an integrated method, system, and apparatus supporting transactions among buyers and sellers of intellectual property, especially intellectual property holdings that are “in progress” in the sense that they are only partially complete, or that they not yet authorized by regulatory bodies. The IPPME also supports options to be transacted on top of the underlying intellectual property holdings, and permits confidential intellectual property holdings to be monetized while respecting requirements for secrecy.

### CROSS-REFERENCE TO RELATED APPLICATIONS

The present application claims priority from U.S. Provisional Application No. 61/166752, filed Apr. 5, 2009, which is incorporated herein by reference

### TECHNICAL FIELD OF THE INVENTION

The present invention, known as the Intellectual Property Pre-Market Engine (IPPME) relates generally to the field of automated entity, data processing, system control, and data communications, and more specifically to an integrated method, system, and apparatus supporting transactions among buyers and sellers of intellectual property, especially intellectual property holdings that are “in progress” in the sense that they are only partially complete, or they are not yet authorized by regulatory bodies. The market also supports options to be transacted on top of the underlying intellectual property holdings.

### BACKGROUND OF THE INVENTION

The present invention relates generally to the field of automated entity, data processing, system control, and data communications, and consists of a system for obtaining bids and offers for complete or in-progress intellectual property holdings or for options associated with those holdings. Because it is advantageous to have a single “mart” for intellectual property holdings (intellectual property holding), the IPPME is available for complete intellectual property holding as well as those in progress. The IPPME supports an extensive variety of complete and in-progress holdings and options, including holdings and options pertaining to Patents, Trademarks, and Copyrights. For most of the following discussion, the example of patent holdings is presented, but analogous arguments can be made for trademarks, copyrights, and their associated assets.

### The Challenge

According to statistics released by the USPTO, patent abandonment has increased sharply, having nearly doubled in the years 2004-2008. Additionally, studies have shown a decreasing willingness of patent holders to pay maintenance fees. Some of this phenomena can be related to higher standards at the USPTO (resulting in fewer allowances) and to the chaotic market for innovation, which orphans entire branches of technology, driven by substitution, globalization, and outright faddism. Unfortunately, we cannot guarantee that only bad patents are abandoned, nor can we guarantee that only useless patents die for lack of maintenance fees. Because patent prosecution is typically lengthy (pendencies of four years are not unusual) and because prosecution is relatively expensive, (average legal costs for prosecution software patents are estimated to be in the neighborhood of $25,000) many patent owners simply run out of money before they can prevail in the prosecution. This “unjustified' destruction of intellectual property hits hardest in small businesses and individual inventors—the very people who provide most of the innovation and growth in the economy.

### Why Protect Intellectual Property?/Why Patent?

Business create patents because they expect to be successful. For large businesses, this is often an expectation of continued success, and the development of a large patent portfolio allows them to negotiate licensing from an advantageous position. Lack of a patent portfolio can doom large businesses to competition strictly on cost, and to commoditization. Trademarks, especially those well known to the public, or engaging of a particular market audience, can also be valuable IPHs. Similarly, in progress or complete copyrightable works, including computer software, art, literature and music have value to a portfolio holder that are potentially distinct from their current market value.

For small businesses, the situation is somewhat different. A patent represents an option which is typically only exercised if the business becomes successful via application of the particular innovation. If the innovation turns out to be useless, the patent (and often the business) may be abandoned. If the innovation is highly successful, then a patent, or even a pending patent application, can prevent even the largest and most predatory infringers from simply stealing the idea. Bad ideas are not the only things that kill small businesses. Lack of capital, market fluctuation, cost of labor, and cost of materiel, and inter-personal breakdowns can also spell doom. These businesses are often left with intellectual property assets “in the pipeline” and may have no way of monetizing those assets. This circumstance represents a waste for all of the parties involved—the inventors or assignees—who may be discarding property, the USPTO, which has invested time and expertise in developing prime facie challenges to the patent, with the goal of sharpening the patent's statement, and the general society, which loses the capital and jobs generated by the IP assets, and may lose technological or artistic benefits, which often languish without capital investment.

In contrast to most financial markets, especially commodity markets, the value of many intellectual property holdings is extremely context dependent. The value of IP is highly dependent on technological and market capabilities of the companies or other entities that acquire it. Thus, an effective market in intellectual property holdings must consider not only the intrinsic value of the intellectual property holding, but also the context-dependent component of that value to the buyer.

An additional concern for owners of in-progress intellectual property holdings is the need to maintain secrecy during the evolution of the intellectual property holding. In the case of patents pending, this may be accomplished by requesting non-publication during the patent's examination. In the case of copy-written material, an author may disclose some elements, artifacts or metadata concerning the intellectual property holding, without disclosing the entirety. This prevents market participants other than the IP owner from obtaining an early sample for (unwarranted) activities such as illegal copying. Another reason for desiring confidentiality with respect to IP development is that an intellectual property holding may not want to telegraph areas of research to market or technology competitors.

Thus, what is needed is a system that can provide market liquidity for intellectual property holdings and can support buyers and sellers of various types of in-progress or complete intellectual property holdings, and for options associated with underlying intellectual property holdings, and for aggregations of intellectual property holdings of all types. The presence of such a market will permit inventors and assignees to realize at least some of the value of their assets, and will often allow them to fund continued prosecution by writing options on the in-progress work, or by selling some intellectual property holdings to fund the development of others. This system must also support intellectual property holding and intellectual property holding owner confidentiality where that confidentiality is requested.

### RELATED ART

There is an existing auction for patents, run by ICAP Ocean Tomo. This service is valuable for holders of issued patents, and for companies specifically desiring a particular patent, but does not provide a protocol designed to support the needs of intellectual property pre-market participants. Another organization, patentauction.com, offers a free service to buyers and sellers of patents, and allows listing of both patented and patent-pending inventions, but provides no way for IP holders to mitigate the disclosure risk involved in advertising pending intellectual property. Additionally, some companies, exemplified by The Hutter Group, LLC. act as “patent matchmakers” who facilitate arrangements between patent owners and potential buyers. These services are also aimed primarily at completed IP (e.g. patents that have issued) rather than in-progress IP. Additionally, some efforts have been made to securitize intellectual property by “selling” it in smaller pieces as described in U.S. Pat. No. 7,228,288 to Elliott entitled “Method of repeatedly securitizing intellectual property assets and facilitating investments therein”, and by writing contracts on patent licenses, as described in United States Application 20060259315 to Malackowski et al. entitled “Intellectual property trading exchange and a method for trading intellectual property rights. U.S. Pat. No. 7,386,460 to Frank, et al.; discloses a “System and method for developing and implementing intellectual property marketing” and U.S. Pat. No. 7,346,518 to Frank , et al. discloses “System and method for determining the marketability of intellectual property assets”—taken together, these inventions are primarily aimed at helping the intellectual property holder monitize his holdings, and make informed decisions with respect to the market.

US Application 20090024513 to Arst, et al. discloses “Methods For Intellectual Property Transactions” and provides a method for establishing a options to purchase or sell IP ownership at (pre determine) prices. This mechanism supports at least some degree of hedging among IP owners and (potential) IP acquirers. US Patent Application 20080140557 to Bowlby et al. discloses an “On-Line Auction System and Method” which supports conditional transfer of rights and factional transaction of rights. U.S. Pat. No. 7,272,572 to Pienkos describes a “Method and system for facilitating the transfer of intellectual property” involving intermediaries who aid in the transfer of intellectual property rights, and providing verification of the value or technological scope of the patent. US Patent Application 20060100948 to Millien, et al. discloses “Methods for creating and valuating intellectual property rights-based financial instruments”, aimed at valuing intellectual property via a pricing system that applies a hedging model to the property right. Though these services, especially when extended to in-progress intellectual property, provide a potential means of monetizing incomplete intellectual property, and even a capability of treating intellectual property holdings as options, they do not offer a market particularly suited to the succession of stages of in-progress value creation and value realization. US Patent Application 20030101073 to Vock, describes a “System and methods for strengthening and commercializing intellectual property”—which includes the publication of pending intellectual property for public view and comment. Such a system is ill-suited to monetization of intellectual property that has not yet been fully disclosed.

### BRIEF OVERVIEW OF THE INVENTION

The current invention provides IP creators and owners with many opportunities to monetize their holdings throughout the development of their property. In the early stages of IP development, owners are justified in their reluctance to disclose material that could compromise the future value of their holdings. At the same time, capital is often needed to complete development, manufacturing, marketing, distribution etc. of properties, and that capital is not given blindly. Additionally, IP holders often face portfolio decisions, where some assets must be dropped in order to pursue others. These “dropped” assets have value, but that value is often unrealized. The present invention supports these IP holders by using IP descriptors that can be used to market the IP without monolithic disclosure of all of its aspects to any single entity, including the IP purchaser. For the IP purchaser, the present invention also offers advantages, as the IP descriptors provide standardized indexing and screening of inventions, and can also provide a level of verification through the use of independent evaluators. IP purchasers can be Venture Capitalists who plan to develop businesses using the holdings, Manufacturers, holders of existing IP portfolio, Media Companies, and financial ventures who seek diversification. Thus the invention provides sellers a market that for property that is ill-served by existing exchanges, and provides buyers with opportunities, practical specificity, protection, and liquidity that is missing in the current IP market. Note that in much of the description that follows, the mechanisms outlined can be used for completed IP as well as in-progress IP, and that a market with general protocols that can handle either completed IP or in-progress IP describes limitations that are not needed for markets consisting purely of completed IP. Once the market for in-progress IP is established, it is anticipated that many types of IP enjoy that market throughout their lifetime, even after they are considered “complete”—as the convenience of finding, and the record of previous evaluation will be useful even for completed IP, after it has initially been marketed as “in-progress” IP. Also note that the thresholds of “completion” are not as crisp as is sometimes assumed by the public. For instance, the scope of claims in issued patents may be expanded up to two years beyond the issuance of those patents, as long as the scope has not previously been surrendered during prosecution. Additionally, patent families have “live” elements for years after the first patent has issued.

In more detail, the present invention integrates several components that are necessary to flexibly provide an intellectual property pre-market system, apparatus, and related services among one or more entities, including: a computer implemented method for providing an intellectual property pre-market among generalized actors comprising the steps of: obtaining at least one intellectual property holding offer from at least one intellectual property holding offerer; obtaining a plurality of intellectual property partial descriptions referring to the intellectual property holding; providing the at least one intellectual property partial description from the plurality of intellectual property partial descriptions to at least one potential intellectual property holding bidder; obtaining at least one intellectual property holding bid from the at least one intellectual property holding bidder; matching the intellectual property holding bid to the intellectual property holding offer; providing the matched intellectual property holding bid and intellectual property holding offer as data that is stored and communicated by the computer system; and a computer implemented method for providing intellectual property pre-market matching among generalized actors comprising the steps of: obtaining at least one first intellectual property description from at least one first generalized actor; obtaining at least one intellectual property holding offer context from the first generalized actor; obtaining at least one second intellectual property description from at least one second generalized actor; obtaining at least one intellectual property holding bid context from the second generalized actor; constructing at least one first set of matches between the intellectual property holding offer and the intellectual property holding bid, in light of the intellectual property holding offer context and the intellectual property holding bid context; selecting at least one subset of appropriate matches from the a first set of matches; and using the appropriate matches to create a market allocating intellectual property holding bids to intellectual property holding offers.

Note that in the following discussion, the word “processor” is used in a generic sense, which indicates merely the ability to execute computer language instructions. The processor can actually be implemented as a virtual machine, and the computer implemented steps can be executed within either a “heavyweight” process or a thread running on such a machine or processor. Computer architectures are moving increasingly to multiple processor approaches, exploiting MPP, and SMP, cluster, grid approaches, and multi-cpu cores, thus allowing software systems that can exploit these architectures to become increasingly practical for business, scientific, and consumer applications.

### Glossary of Terms

Computer-accessible artifact (computer accessible artifact): An item of information, media, work, data, or representation that can be stored, accessed, and communicated by a computer.

Data Mining, Knowledge Discovery: The practice of searching stores of data for information, knowledge, data or patterns, specifically for the non-trivial extraction of useful information incorporating computational techniques from statistics, machine learning, pattern recognition and artificial intelligence.

Data source: An accessible repository or generator of data, such as a database, simulation, or sensor stream, typically in a structured format such as a CSV, flat-file, relational database, network database, delimited structure, index file, data file, document collection, web-site or database.

Generalized actor (generalized actor): one user or a group of users, or a group of users and software agents, or a computational entity acting in the role of a user, which behaves in a way to achieve some goal.

Scalability: The ability of a computer system, architecture, network or process which allows it to pragmatically meet demands for larger amounts of processing by use of additional processors, memory, and connectivity.

Data Mining or Machine Learning method: A method of building a model to make predictions about the value of variables or about the identity or category of variables, by examining relevant data and constructing a relationship that may be used to make predictions given subsequent data, including but not limited to the methods of: AdaBoost, artificial neural networks, auto-regressive integrated moving averages, bagging, Bayesian analysis clustering, Bayesian influence networks, boosting, C4.5, C5.0, Chi-square automatic interaction detection, clustering by expectation, competitive learning, constrained association rule approaches, density-based clustering, deviation-based outlier detection, distance-based outlier detection, error minimization via robust optimization, frequent-pattern tree approaches, generalization-tree approaches, generalized autoregressive conditional heteroskedastic methods, hidden-Markov models, hierarchical learning, hypergraph partitioning algorithms, ID3, incremental conceptual clustering, inductive logic programming, inferred rules, Kalman filtering, kernel methods, k-means clustering, k-medoids clustering, latent semantic indexing, linear regression, Logit regression, multi-resolution grid clustering, non-linear regression, one-R, principal component analysis, radial basis functions, regression tree approaches, robust clustering using links, rough-set classifiers, Self-organizing maps, stacking, support vector machines, the direct hashing and pruning algorithm, the dynamic itemset counting algorithm, time-series learning, unsupervised learning, vertical itemset partitioning algorithms, vertical-layout algorithms, Voronoi diagrams, wagging, wavelets, and zero-R.

### BRIEF DESCRIPTION OF THE DRAWINGS

FIG. 1 shows a high-level view of the intellectual property pre-market engine (IPPME).

FIG. 2 depicts obtaining intellectual property holding offers.

FIG. 3 illustrates obtaining intellectual property holding descriptions.

FIG. 4 outlines matching the intellectual property holding bid to the intellectual property holding offer.

FIG. 5 portrays obtaining commitments and performing transactions.

FIG. 6 provides an exemplary IPPME use case.

FIG. 7 illustrates an exemplary distributed architecture for the IPPME.

FIG. 8 outlines extracting terminology from intellectual property holding Artifacts and Metadata.

FIG. 9 depicts constructing matches based on value prediction.

FIG. 10 shows constructing matches based on context prediction.

FIG. 11 portrays construct matches based on consensus among matching methods.

FIG. 12 provides exemplary multi-term selection via island expansion.

FIG. 13 provides exemplary obtaining IP descriptions from an intellectual property holding offer.

### DETAILED DESCRIPTION OF THE INVENTION

Detailed descriptions of exemplary embodiments of the IPPME invention and the accompanying figures, provide specific and general illustrations of exemplary embodiments wherein the invention may be practiced. Descriptions of the exemplary embodiments provide sufficient detail to enable those skilled in the art to practice the invention without undue experimentation, given existing technologies well-known in the art. Obvious other embodiments can be utilized wherein changes to various aspects of the invention may be implemented without departing from the spirit of the invention. The descriptions are not to be taken in any limiting sense, but are presented so as to illustrate specific embodiments of the instant invention. Discussions of the following detailed descriptions are presented in terms of computer instructions, computer representations, and symbolic representation of data existing and or operating within at least one computer memory, computer system, module, other memory, virtual machine, collection of computers or equivalent devices. Reference to the processing and manipulation of the data reflects processing and manipulation of physical quantities within computer systems or equivalent devices, which cause a physical changes in those devices. The data manipulations are well known to those in the art, and the IPPME system, method, and apparatus produce useful, concrete and tangible results, consisting of new markets for intellectual property holdings, and mechanism to permit better and more pervasive monetization of intellectual property holdings throughout their lifetime, and mechanism to serve individual intellectual property holding owners, group intellectual property holding owners, individual intellectual property holding buyers and group intellectual property holding buyers, as well as parties, such as research and development or marketing groups who benefit indirectly from the IPPM by gaining information concerning the market value of innovations. The figures depict information flow and key tasks and preferred embodiments of the instant invention, however each embodiment's (possible, illustrated or described) ordering of steps depicted in the illustrations should be considered as exemplary and not limiting, regarding the scope of the invention. In most cases, alternative ordering of steps is useful, especially for some variations of the implementation, and those alternative ordering of steps and their descriptions are fully anticipated and encompassed by the current specification. It should also be noted that the list of potential application domains is enormous, and that the few domains mentioned are exemplary and not in any way limiting. In general, the invention can be used in varied fields such as finance, product development, venture capital formation, technology research and development, joint venture formation, technology hedging, and government funding of technology development.

### Distributed Processing

the IPPME can be applied as one or more processes distributed over multiple processors, either locally or remotely or both. In a preferred embodiment, a federated, distributed computing system provides mechanisms for decentralized distributed processing of the IPPME processes, along with appropriate authorization ownership and control of artifacts and services. All of the processor-intensive operations of the IPPME can be distributed over an arbitrary number of processors.

Distributed Processing through Grid Computing, Cloud Computing and Special Purpose Parallel Computing.

Grid computing architectures employ multiple separate computers' resources connected by a network, such as an intranet and/or the Internet, to execute large-scale computational tasks by modeling a virtual computer architecture. Grids provide a framework for performing computations on large data sets, and can perform many operations by division of labor between the member processors. Grid technology supports flexible computational provisioning beyond the local (home) administrative domain. Cloud computing systems offer computing as a service, and may expose this service through either centralized entry-points, or via peer-to-peer networks. Commercial cloud computing is typically leased by time and/or resource consumption, allowing for large peak capacity at relatively low capital cost. In a preferred embodiment, the IPPME can be implemented on grid or cloud computing systems. The instant invention can also exploit additional special purpose computing resources such as single instruction, single data stream (SISD) computers, multiple instruction, single data stream (MISD) computers, single instruction, multiple data streams (SIMD) computers, multiple instruction, multiple data streams (MIMD) computers, and single program, multiple data streams (SPMD) computer architectures, and can exploit arbitrary heterogeneous combinations of specialized parallel computing systems and general-purpose computers.

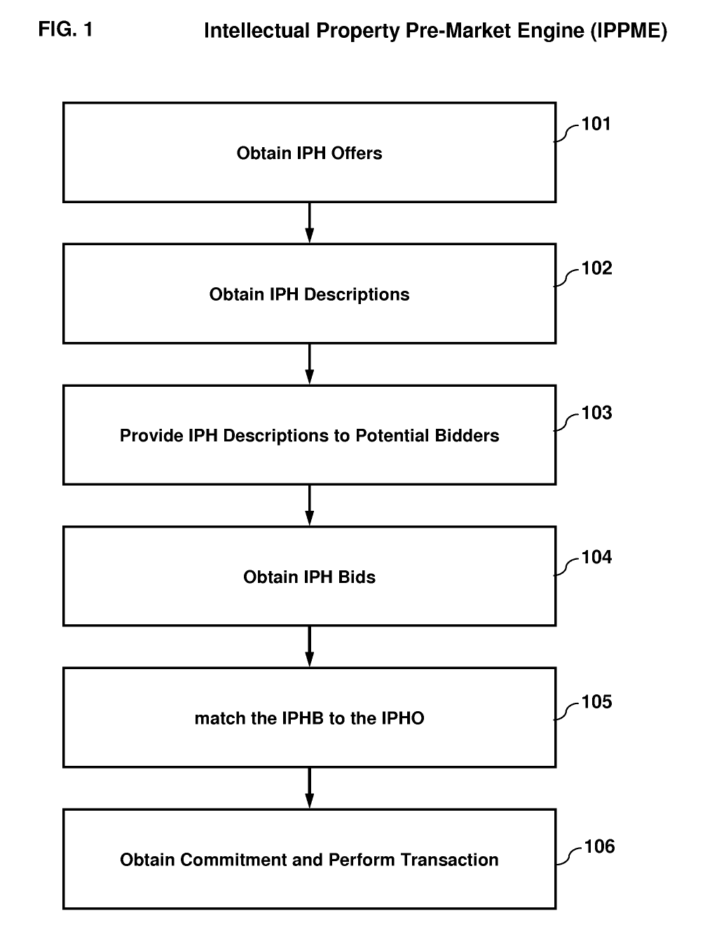

FIG. 1. Intellectual Property Pre-Market Engine (IPPME) consists of: 101 Obtaining intellectual property holding offers. 102 Obtaining intellectual property holding Descriptions. 103 Providing intellectual property holding Descriptions to Potential Bidders. 104 Obtaining intellectual property holding Bids. 105 Matching the intellectual property holding bid to the intellectual property holding offer. And 106 obtaining Commitments and Performing Transactions

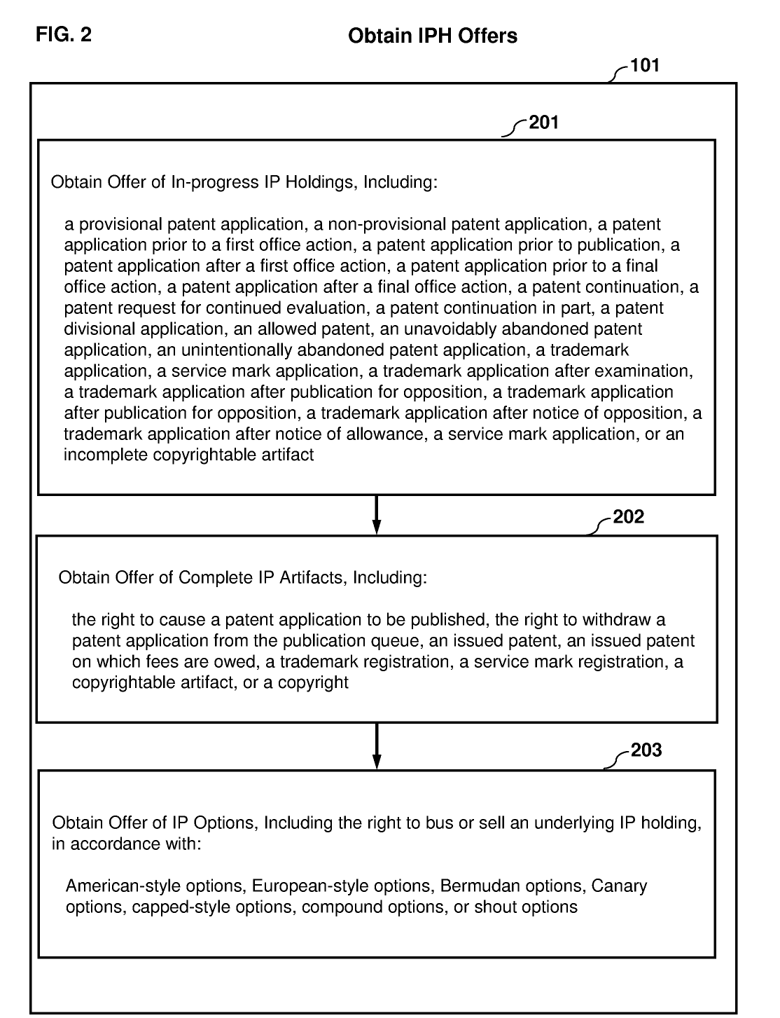

FIG. 2 Obtain intellectual property holding Offers consists of: 201 Obtain Offer of In-progress IP Holdings, Including: a provisional patent application, a non-provisional patent application, a patent application prior to a first office action, a patent application prior to publication, a patent application after a first office action, a patent application prior to a final office action, a patent application after a final office action, a patent continuation, a patent request for continued evaluation, a patent continuation in part, a patent divisional application, an allowed patent, an unavoidably abandoned patent application, an unintentionally abandoned patent application, a trademark application, a service mark application, a trademark application after examination, a trademark application after publication for opposition, a trademark application after publication for opposition, a trademark application after notice of opposition, a trademark application after notice of allowance, a service mark application, or an incomplete copyrightable artifact; 202 Obtain Offer of Complete IP Artifacts, Including: the right to cause a patent application to be published, the right to withdraw a patent application from the publication queue, an issued patent, an issued patent on which fees are owed, a trademark registration, a service mark registration, a copyrightable artifact, or a copyright. And 203 Obtain Offer of IP Options, Including the right to bus or sell an underlying IP holding.

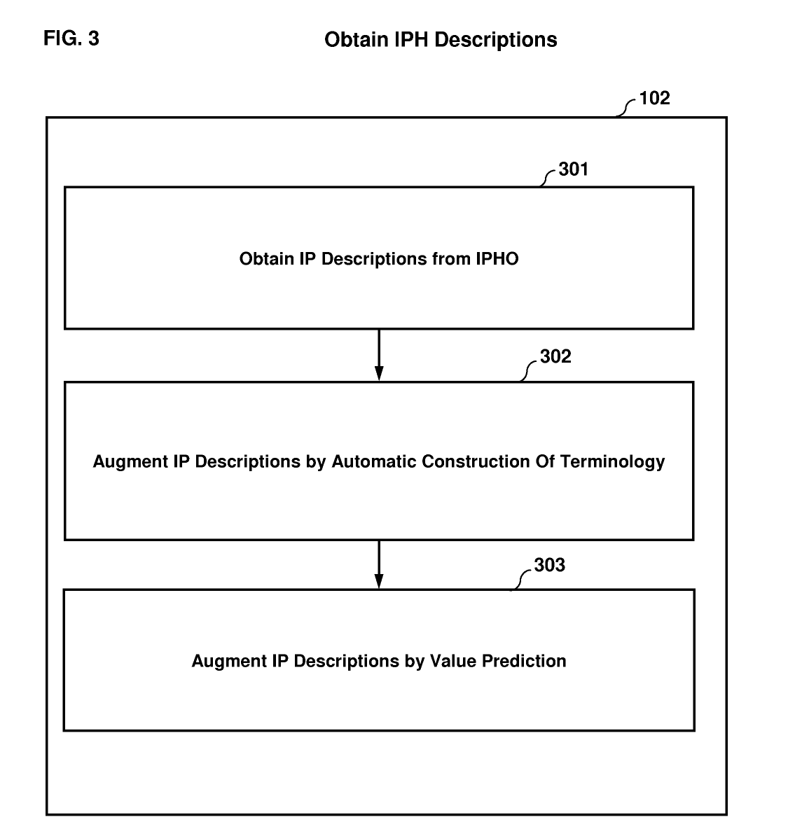

FIG. 3 illustrates obtaining intellectual property holding descriptions, including: 301 Obtain IP Descriptions from intellectual property holding offer. 302 Augment IP Descriptions by Automatic Construction Of Terminology, using data mining or machine learning methods. And 303 Augment IP Descriptions by Value Prediction using data mining or machine learning methods or expert third-party evaluations, or evaluations obtained from social networking information.

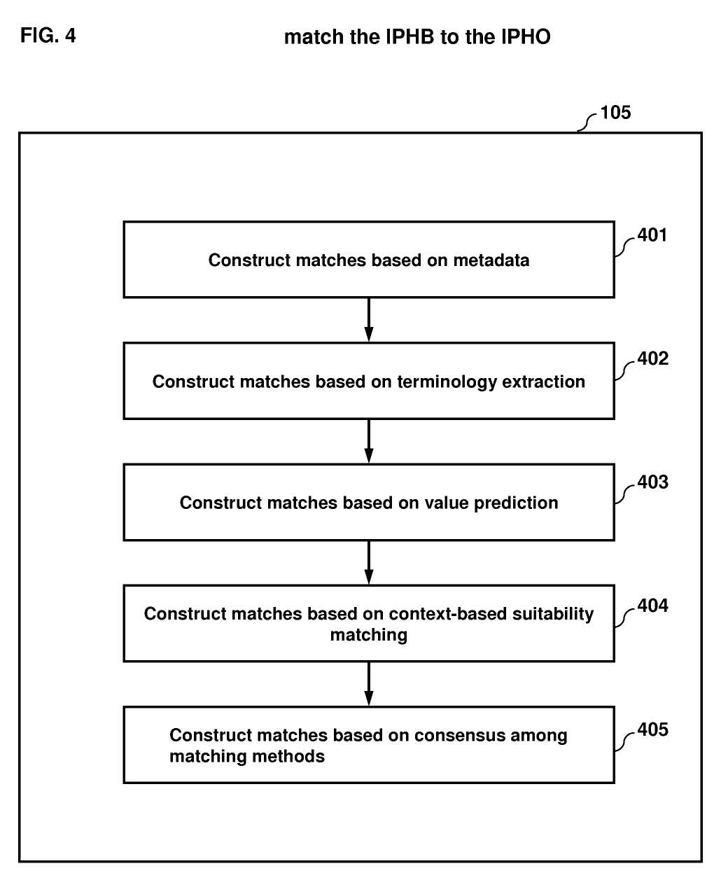

FIG. 4 outlines matching the intellectual property holding bid to the intellectual property holding offer, including: 401 Construct matches based on metadata. 402 Construct matches based on terminology extraction; 403 Construct matches based on value prediction. 404 Construct matches based on context-based suitability matching. And 405 construct matches based on consensus among matching methods.

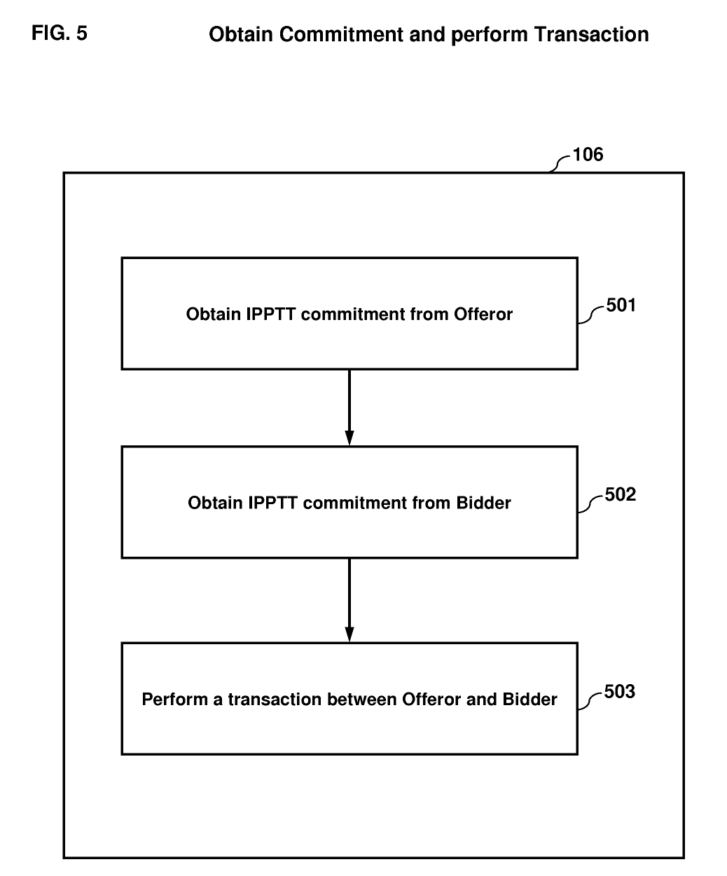

FIG. 5 portrays obtaining commitments and performing transactions, including: 501 Obtain intellectual property transfer terms commitment from Offeror. 502 Obtaining intellectual property transfer terms commitment from Bidder. And 503 Perform a transaction between Offeror and Bidder.

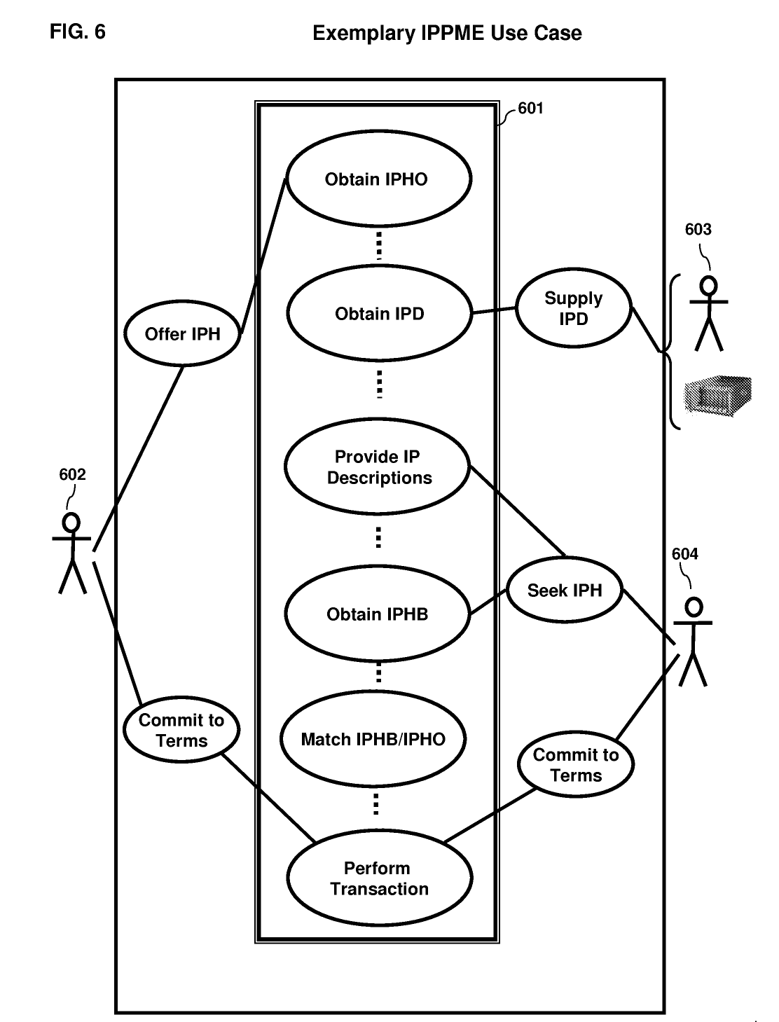

FIG. 6 provides an exemplary IPPME use case. 601 indicates the activities that take place within the core of the IPPME. A First generalized actor, 602 makes an offer for some intellectual property holding. A second generalized actor 603 provides a description for the intellectual property holding. Note that in cases where confidentiality is required, 603 may be purely automated as a computer system, or may be implemented as multiple partitions, each of whom see only a section of the intellectual property holding artifacts or metadata, and that the intellectual property holding artifacts or metadata may be filtered, translated, obfuscated, or redacted to maintain confidentiality. A third generalized actor, 604 seeks an intellectual property holding, views an intellectual property description, and makes an intellectual property holding bid. The core IPPME matches the intellectual property holding bid and intellectual property holding offer, constructs terms for both parties agreement, gains that agreement, and performs the transaction indicated by the terms.

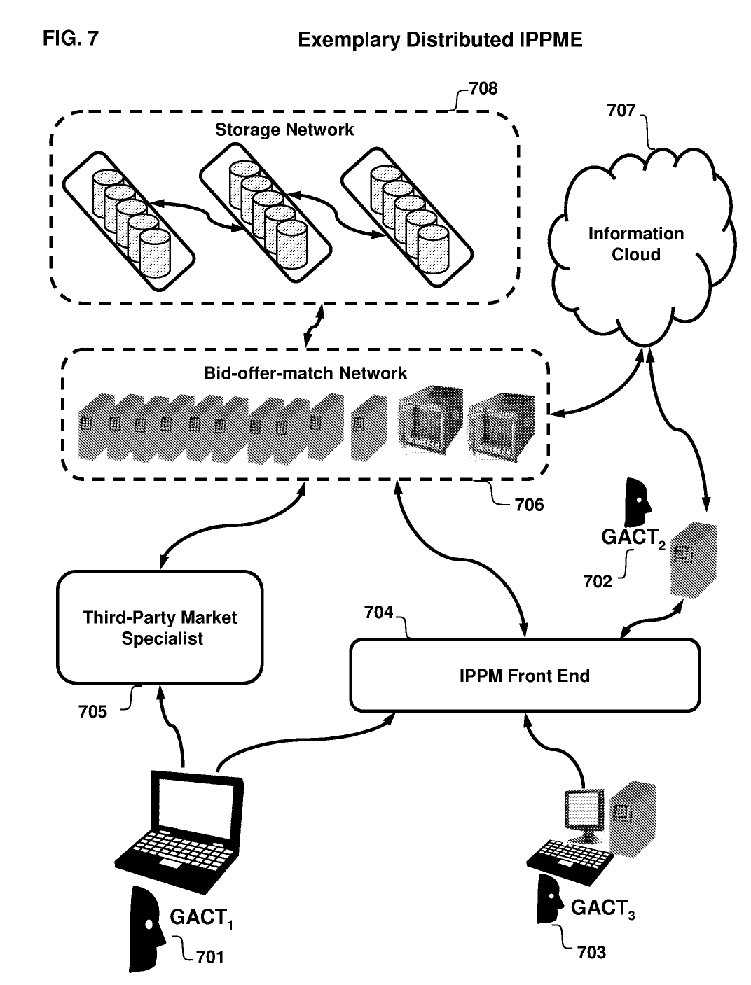

FIG. 7 illustrates an exemplary distributed architecture for the IPPME, including: 701 generalized actor1 who corresponds with 705 a Third-Party Market Specialist or with 704 the IPPM Front End. 702 generalized actor2 who interacts with 704 and with the information cloud (Internet, news sources, IP databases) to construct appropriate descriptions of an intellectual property holding. 703 generalized actor3 who corresponds with 704, to accomplish an intellectual property holding transaction. 706, the bid-offer-match network is distributed over any number of processors, or any general-purpose parallel computing system or cloud, including symmetric multiprocessing (SMP), asymmetrical multiprocessing (ASMP), Non-Uniform Memory Access (NUMA) computing, Massive parallel processing (MPP), multi-core processing, cluster computing, grid computing, and cloud computing. 706 routes bids and offers with shared or complementary descriptors to particular internal market makers. To guarantee that this system is robust to various failures, data is stored redundantly in the 708 storage network, and the entire system is operated with a fail-over capability.

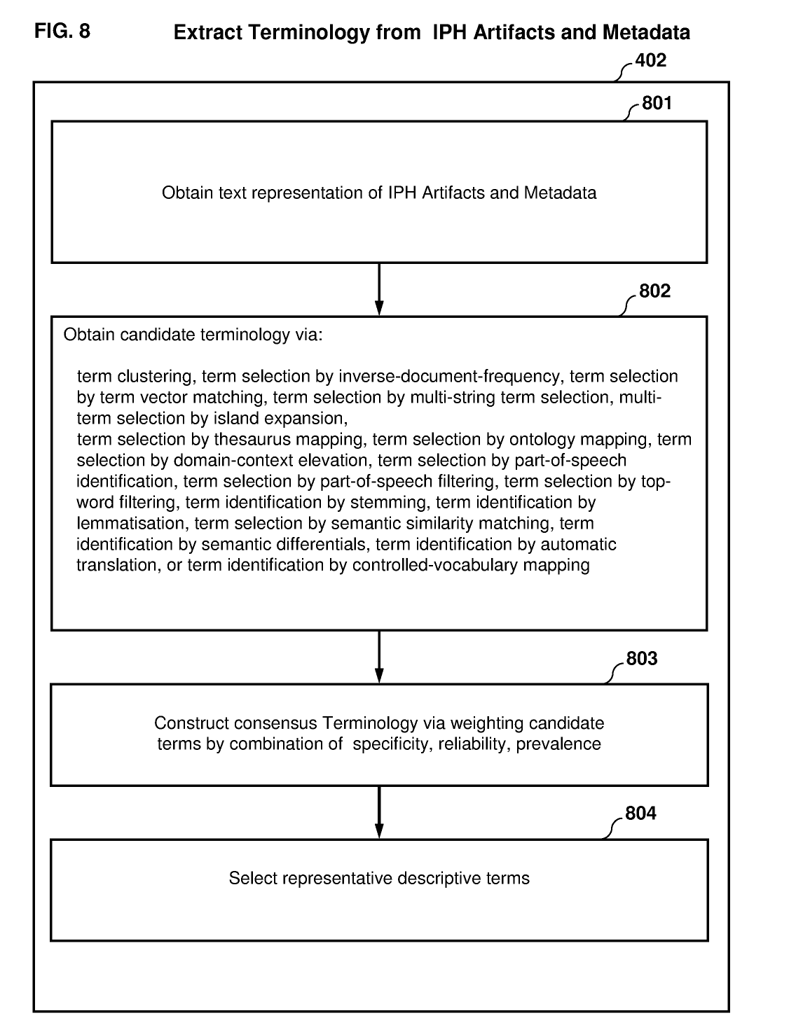

FIG. 8 outlines extracting terminology from intellectual property holding Artifacts and Metadata, including: 801 Obtain text representation of intellectual property holding Artifacts and Metadata. 802 Obtaining candidate terminology via: term clustering, term selection by inverse-document-frequency, term selection by term vector matching, term selection by multi-string term selection, multi-term selection by island expansion, term selection by thesaurus mapping, term selection by ontology mapping, term selection by domain-context elevation, term selection by part-of-speech identification, term selection by part-of-speech filtering, term selection by top-word filtering, term identification by stemming, term identification by lemmatisation, term selection by semantic similarity matching, term identification by semantic differentials, term identification by automatic translation, or term identification by controlled-vocabulary mapping. 803 Constructing consensus Terminology via weighting candidate terms by combination of specificity, reliability, prevalence. And 804 Selecting representative descriptive terms.

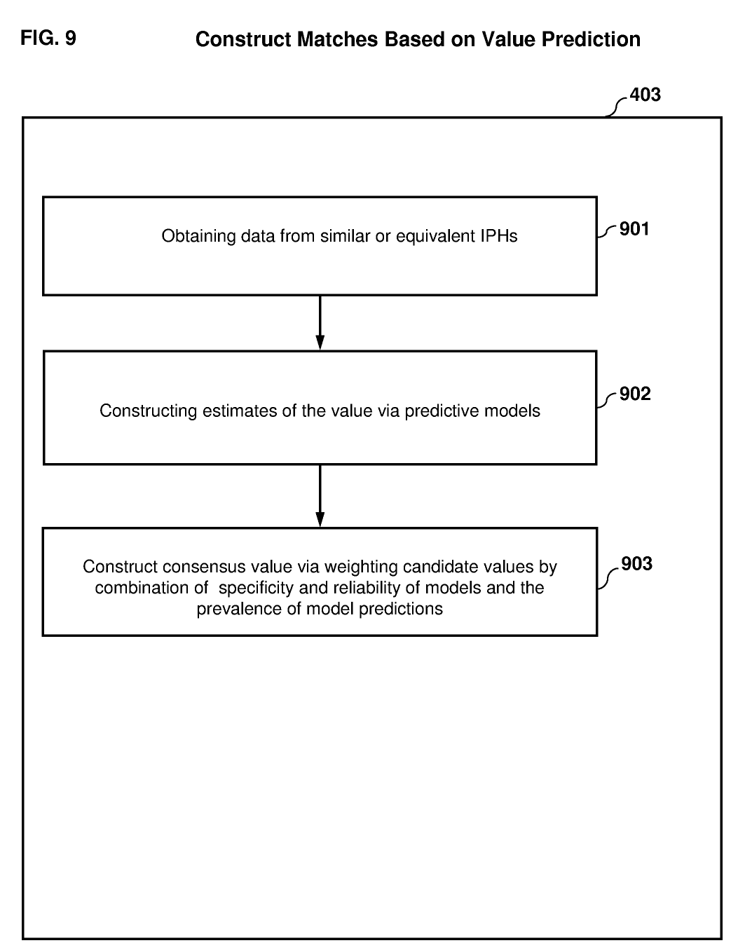

FIG. 9 depicts constructing matches based on value prediction, including: 901 Obtaining data from similar or equivalent intellectual property holdings. 902 Constructing estimates of the value via predictive models using data mining or machine learning methods. And 903 Constructing consensus value via weighting candidate values by combination of specificity and reliability of models and the prevalence of model predictions.

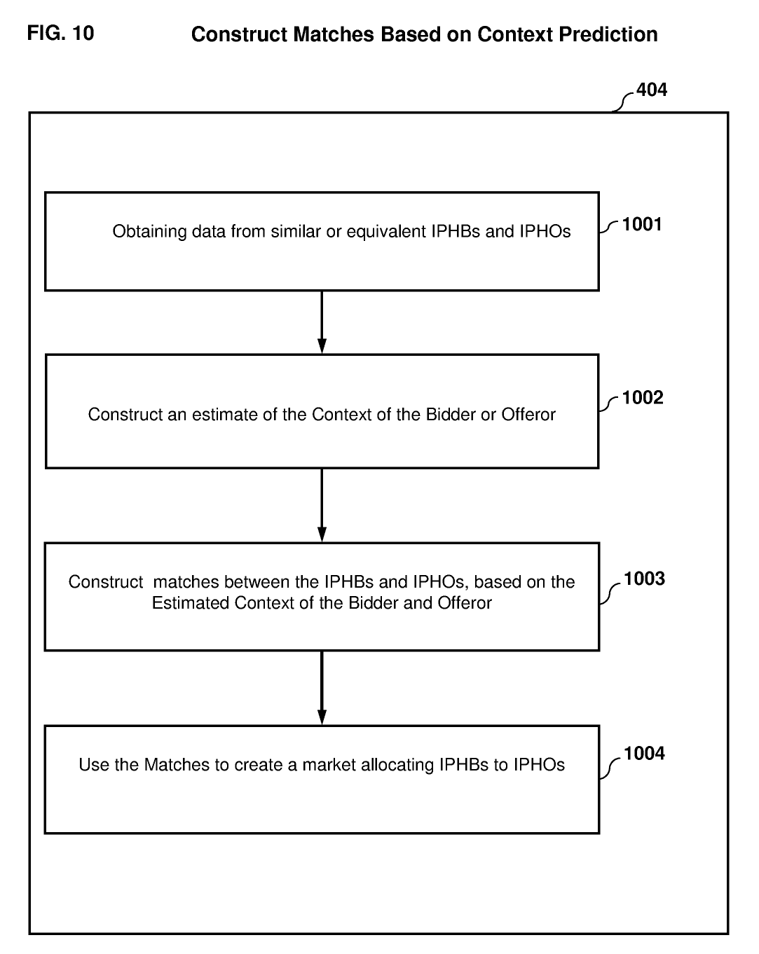

FIG. 10 shows Constructing Matches Based on Context Prediction, including: 1001 Obtaining data from similar or equivalent intellectual property holding bids and intellectual property holding offers. 1002 Constructing an estimate of the Context of the Bidder or Offeror using data mining or machine learning methods. 1003 Construct matches between the intellectual property holding bids and intellectual property holding offers, based on the Estimated Context of the Bidder and Offeror using data mining or machine learning methods. And 1004 Using the Matches to create a market allocating intellectual property holding bids to intellectual property holding offers.

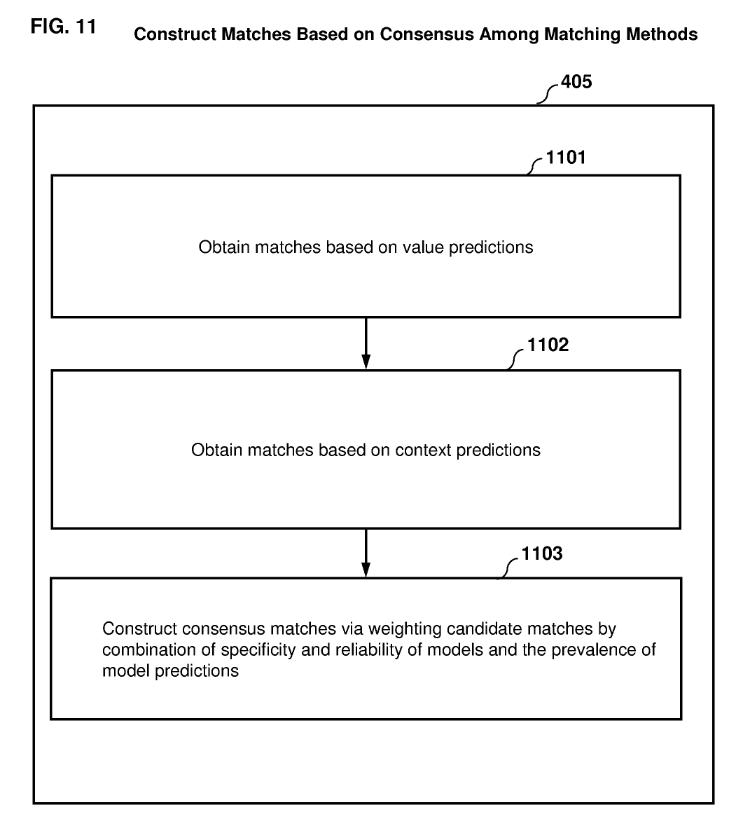

FIG. 11 portrays Construct Matches Based on Consensus Among Matching Methods, including: 1101 Obtaining matches based on value predictions. 1102 Obtaining matches based on context predictions using data mining or machine learning methods. And 1103 Construct consensus matches via weighting candidate matches by combination of specificity and reliability of models and the prevalence of model predictions.

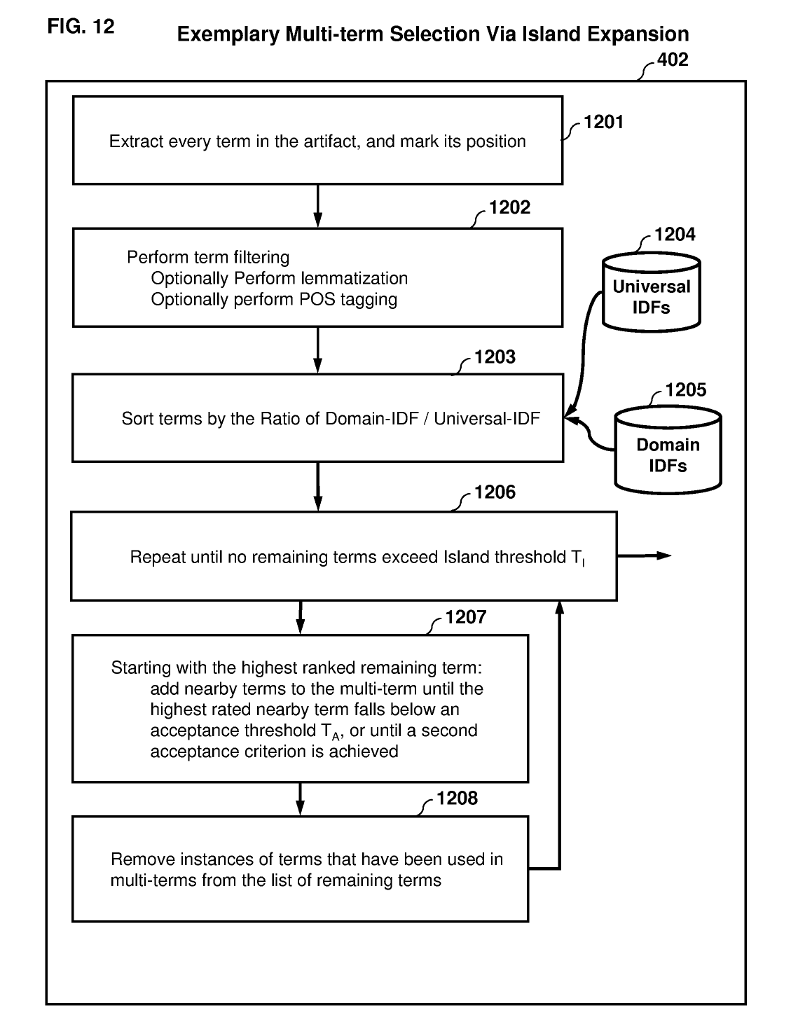

FIG. 12 provides exemplary multi-term selection via island expansion, including: 1201 Extracting every term in the artifact, and mark its position. 1202 Performing term filtering and Optionally Performing lemmatization and Optionally perform POS tagging. 1203 Sorting terms by the Ratio of Domain-IDF/Universal-IDF, using 1204 a database of universal IDFs drawn from a corpus such as the text of wikipedia or newspaper archives; and using 1205 a domain-specific database of IDFs drawn from other artifacts related to the intellectual property holding by common technology or market. These same-domain documents can be retrieved by encoding the intellectual property holding terms and metadata into general indices, such as the USPTO Classification System (USPC).

FIG. 12 continues with the following procedure, repeated (1206) until no remaining terms exceed Island threshold TI: 1207 Starting with the highest ranked remaining term: add nearby terms to the multi-term until the highest rated nearby term falls below an acceptance threshold TA, or until a second acceptance criterion is achieved. Typical second criteria include: a maximum length of the multi-term, and a progressively rising threshold. 1208 Removing instances of terms that have been used in multi-terms from the list of remaining terms. Note that many other term extraction methods can be used in the IPPME, alone, or in conjunction with the island-expansion method, including: term clustering, term selection by inverse-document-frequency, term selection by term vector matching, term selection by multi-string term selection, term selection by thesaurus mapping, term selection by ontology mapping, term selection by domain-context elevation, term selection by part-of-speech identification, term selection by part-of-speech filtering, term selection by top-word filtering, term identification by stemming, term identification by lemmatisation, term selection by semantic similarity matching, term identification by semantic differentials, term identification by automatic translation, and term identification by controlled-vocabulary mapping.

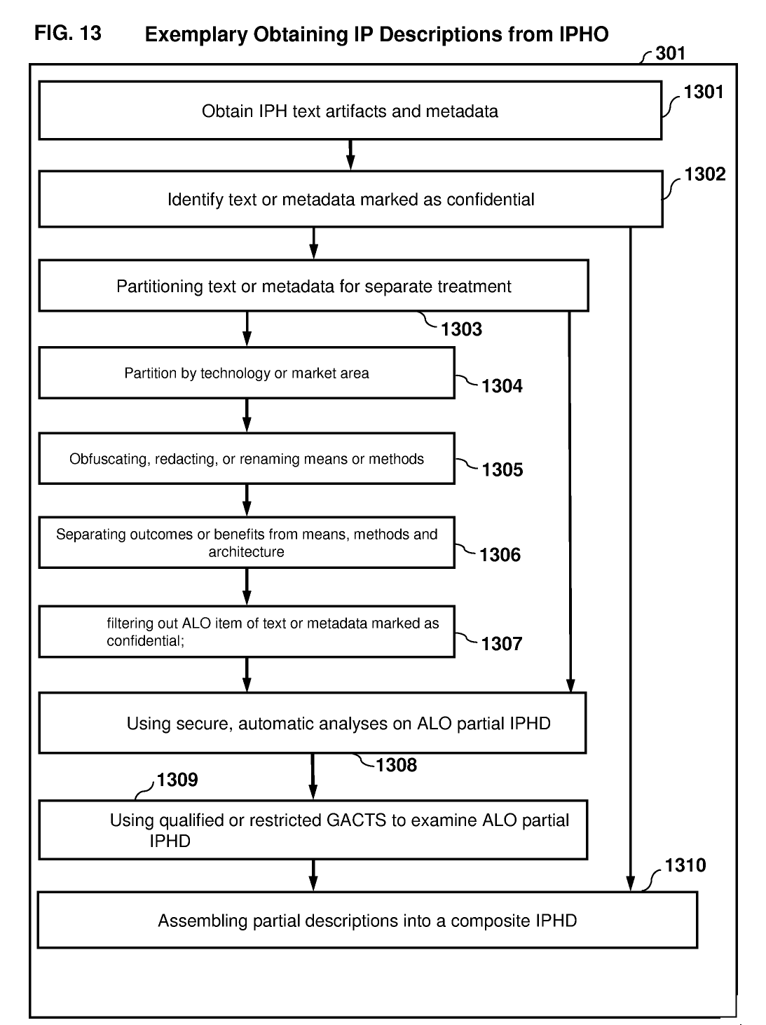

FIG. 13 provides exemplary obtaining IP descriptions from an intellectual property holding offer, including: 1301 Obtaining intellectual property holding text artifacts and metadata. 1302 Identifying text or metadata marked as confidential. 1303 Partitioning text or metadata for separate treatment. 1304 Partitioning by technology or market area. 1305 Obfuscating, redacting, or renaming means or methods. 1306 Separating outcomes or benefits from means, methods and architecture. 1307 filtering out at least one item of text or metadata marked as confidential. 1308 Using secure, automatic analyses on at least one partial intellectual property holding description. 1309 Using qualified or restricted generalized actors to examine at least one partial intellectual property holding description. And 1310 assembling partial descriptions into a composite intellectual property holding description.

What is claimed is:

1. In a computer system, having one or more processors or virtual machines, one or more memory units, one or more input devices and one or more output devices, optionally a network, and optionally shared memory supporting communication among the processors, a computer implemented method for providing an intellectual property pre-market among generalized actors comprising the steps of:
a) obtaining at least one intellectual property holding offer from at least one intellectual property holding offerer;
b) obtaining a plurality of intellectual property partial descriptions referring to the intellectual property holding;
c) providing the at least one intellectual property partial description from the plurality of intellectual property partial descriptions to at least one potential intellectual property holding bidder;
d) obtaining at least one intellectual property holding bid from the at least one intellectual property holding bidder;
e) matching the intellectual property holding bid to the intellectual property holding offer; and
f) providing the matched intellectual property holding bid and intellectual property holding offer as data that is stored and communicated by the computer system.

2. The method of claim 1 further comprising constructing at least one intellectual property transfer term relating to the intellectual property holding
a) obtaining a commitment to the intellectual property transfer term from the intellectual property holding offerer;
b) obtaining a commitment to the intellectual property transfer term from the intellectual property holding bidder; and
c) performing a transaction between the intellectual property holding offerer and the intellectual property holding bidder.

3. The method of claim 1 further comprising using an intellectual property holding comprising constructing an intellectual property description computer artifact and using the computer artifact in performing a transaction between the intellectual property holding offerer and the intellectual property holding bidder, and performing transaction between intellectual property holding offerer and the intellectual property holding bidder.

4. The method of claim 1 further comprising the steps of:
a) obtaining a plurality of intellectual property partial description domain restrictions from the intellectual property holding offerer, wherein the domain restrictions stipulate domains of the intellectual property holding description that must be evaluated separately; and
b) obtaining at least one first intellectual property partial description from a at least one first intellectual property partial description provider and at least one second intellectual property partial description from at least one second intellectual property partial description provider, wherein the first provider and the second provider are prevented from communicating about the intellectual property holding.

5. The method of claim 1 further comprising obtaining at least one intellectual property holding proxy description from the intellectual property holding offerer wherein the intellectual property holding proxy description reveals aspects of the intellectual property holding appropriate to a particular intellectual property partial description provider.

6. The method of claim 1 further comprising using an intellectual property holding comprising at least one in-progress underlying holding selected from the group consisting of:
a provisional patent application, a non-provisional patent application, a patent application prior to a first office action, a patent application prior to publication, a patent application after a first office action, a patent application prior to a final office action, a patent application after a final office action, a patent application continuation, a patent request for continued evaluation, a patent continuation in part, a patent divisional application, an allowed patent, an unavoidably abandoned patent application, an unintentionally abandoned patent application, a trademark application, a service mark application, a trademark application after examination, a trademark application after publication for opposition, a trademark application after publication for opposition, a trademark application after notice of opposition, a trademark application after notice of allowance, a service mark application, and an incomplete copyrightable artifact.

7. The method of claim 1 further comprising using an intellectual property holding comprising at least one option holding written in an underlying holding wherein the option holding is an option to buy or to sell at least one underlying holding and wherein the option has an associated strike price and an expiration date, and in which the option may be exercised in accordance with at least one option style selected from the group consisting of:
American-style options, European-style options, Bermudan options, Canary options, capped-style options, compound options, or shout options.

8. The method of claim 1 further comprising using an intellectual property holding comprising at least one option to affect or exploit an underlying holding wherein the option to modify is at least one selected from the group consisting of:
the right to cause a patent application to be published, the right to withdraw a patent application from the publication queue, the right to divide a patent application into divisional applications, the right to make a related foreign application, the right to make a national stage application, the right to make an international application, the right to make a regional application, at least partial rights to an issued patent, at least partial rights to an issued patent on which fees are owed, at least partial rights to a trademark registration, at least partial rights a service mark registration, at least partial rights to a copyrightable artifact, at least partial rights to a copyright, the obligation to cause a patent application to be published, the obligation to withdraw a patent application from the publication queue, the obligation to divide a patent application into divisional applications, the obligation to make a related foreign application, the obligation to make a national stage application, the obligation to make an international application, the obligation to make a regional application, at least partial obligations to license an issued patent, at least partial obligations to pay fees owed on an issued patent, at a least partial obligation to license a trademark, at least a partial obligation to license a service mark, at least partial obligation to license a copyrightable artifact, and at least partial obligation to license a copyright.

9. The method of claim 1 further comprising using an intellectual property holding comprising breaking initial intellectual property holding artifact text or metadata into a plurality of parts, obtaining a plurality of partial intellectual property holdings corresponding to the parts, and assembling a subset of the intellectual property holdings into a composite intellectual property holding, optionally including at least one additional step selected from the group consisting of of:
a) partitioning text or metadata by technology or market area;
b) separating outcomes or benefits from means, methods and architecture;
c) identifying any text or metadata marked as confidential;
d) filtering out at least one item of text or metadata marked as confidential;
e) using only qualified or restricted generalized actors to examine at least one partial intellectual property holding;
f) using only secure, automatic analyses on at least one partial intellectual property holding; and
g) automatically obfuscating, redacting, or renaming means or methods.

10. The method of claim 1 further comprising using an intellectual property holding comprising obtaining the intellectual property description from at least one system that automatically constructs at least one descriptive term from intellectual property holding artifacts or intellectual property holding metadata by at least one method selected from the group consisting of:
term clustering, term selection by inverse-document-frequency, term selection by term vector matching, term selection by multi-string term selection, multi-term selection by island expansion,
term selection by thesaurus mapping, term selection by ontology mapping, term selection by domain-context elevation, term selection by part-of-speech identification, term selection by part-of-speech filtering, term selection by top-word filtering, term identification by stemming, term identification by lemmatisation, term selection by semantic similarity matching, term identification by semantic differentials, term identification by automatic translation, and term identification by controlled-vocabulary mapping.

11. The method of claim 1 further comprising using an intellectual property holding comprising obtaining the intellectual property description by additional steps of:
a) obtaining a plurality of descriptive terms from a plurality of instances of generalized actors;
b) weighting candidate terms by at least one method selected from the group consisting of:
specificity, reliability, and prevalence; and
c) constructing at least one consensus description from the descriptive terms.

12. The method of claim 1 further comprising using an intellectual property holding comprising obtaining the intellectual property description by additional steps of:
a) obtaining a plurality of term-mappings from a plurality of term-abstraction indices;
b) using the term-mappings to construct a plurality of alternative sets of descriptive terms;
c) constructing at least one consensus description from the alternative sets a plurality of descriptions.

13. The method of claim 1 further comprising the steps of:
a) obtaining data from similar or equivalent intellectual property holding by data mining at least one set of data selected from the group consisting of:
historical transactions, financial records, polling of expert opinion, securities and exchange commission data, USPTO data, equities data, options data, and futures data;
b) constructing at least one estimate of the value of the intellectual property holding, wherein the of estimation method includes at least one technique selected from the group consisting of:
AdaBoost, artificial neural networks, auto-regressive integrated moving averages, bagging, Bayesian analysis clustering, Bayesian influence networks, boosting, C4.5, C5.0, Chi-square automatic interaction detection, clustering by expectation, competitive learning, constrained association rule approaches, density-based clustering, deviation-based outlier detection, distance-based outlier detection, error minimization via robust optimization, frequent-pattern tree approaches, generalization-tree approaches, generalized autoregressive conditional heteroskedastic methods, hidden-Markov models, hierarchical learning, hypergraph partitioning algorithms, ID3, incremental conceptual clustering, inductive logic programming, inferred rules, Kalman filtering, kernel methods, k-means clustering, k-medoids clustering, latent semantic indexing, linear regression, Logit regression, multi-resolution grid clustering, non-linear regression, one-R, principal component analysis, radial basis functions, regression tree approaches, robust clustering using links, rough-set classifiers, Self-organizing maps, stacking, support vector machines, the direct hashing and pruning algorithm, the dynamic itemset counting algorithm, time-series learning, unsupervised learning, vertical itemset partitioning algorithms, vertical-layout algorithms, Voronoi diagrams, wagging, wavelets, and zero-R;
c) weighting candidate values by at least one method selected from the group consisting of:
specificity, reliability, prevalence; and
d) using the weighed estimate of value as a component of the intellectual property description.

14. The method of claim 1 further comprising constructing bundled of intellectual property holding offers or intellectual property holding bids, by the steps of:
a) identifying at least one unifying IP sector or instrument;
b) finding at least one subset of intellectual property holding offers or intellectual property holding bids that are appropriate to the IP sector or instrument;
c) aggregating at least one intellectual property holding offer or at least one intellectual property holding bid from the subset;
d) constructing a bundled intellectual property holding offer or intellectual property holding bid to be used in subsequent market operations; and
e) offering at least one bundled intellectual property holding offer or intellectual property holding bid, wherein the bundle is related to a specific sector or instrument.

15. The method of claim 1 further comprising transacting market commitments of bundled of intellectual property holding offers or bundled intellectual property holding bids, by the steps of:
a) identifying at least one unifying IP sector or instrument;
b) finding at least one subset of intellectual property holding offers or intellectual property holding bids that are appropriate to the IP sector or instrument;
c) aggregating at least one intellectual property holding offer or at least one intellectual property holding bid from the subset;
d) constructing a bundled intellectual property holding offer or intellectual property holding bid to be used in subsequent market operations; and
e) offering at least one bundled intellectual property holding offer or intellectual property holding bid, wherein the bundle is related to a specific sector or instrument;
f) performing market transactions on the best matches directly or optionally by providing transaction pre-commitment allocations to at least one specialist who has knowledge or expertise in the unifying IP sector or the unifying IP instrument;
g) obtaining a commitment to the bundled intellectual property holding offer from the bundled intellectual property holding bid; and
h) performing a transaction committing the bundled intellectual property holding offer or intellectual property holding bid.

16. The method of claim 1, further comprising distributing the method for finding a match between the intellectual property holding offer and the intellectual property holding bid by distributing the computation over multiple processors, using at least one multiprocessor computation method selected from the group consisting of:
symmetric multiprocessing (SMP), asymmetrical multiprocessing (ASMP), thread-level multi-processing, cellular architecture processing, Non-Uniform Memory Access(NUMA) computing, Massive parallel processing (MPP), multi-core processing, cluster computing, grid computing, and cloud computing.

17. In a computer system, having one or more processors or virtual machines, one or more memory units, one or more input devices and one or more output devices, optionally a network, and optionally shared memory supporting communication among the processors, a computer implemented method for providing intellectual property pre-market matching among generalized actors comprising the steps of:
a) obtaining at least one first intellectual property description from at least one first generalized actor;
b) obtaining at least one intellectual property holding offer context from the first generalized actor;
c) obtaining at least one second intellectual property description from at least one second generalized actor;
d) obtaining at least one intellectual property holding bid context from the second generalized actor;
e) constructing at least one first set of matches between the intellectual property holding offer and the intellectual property holding bid, in light of the intellectual property holding offer context and the intellectual property holding bid context;
f) selecting at least one subset of appropriate matches from the a first set of matches; and
g) using the appropriate matches to create a market allocating intellectual property holding bids to intellectual property holding offers.

18. The method of claim 17 further comprising using appropriate matches in an market wherein the market mechanism comprises at least one mechanism selected from the group consisting of:
a) estimated excess value maximization, committed market clearing, auction, descending price auction, ascending price auction, English auction, Dutch auction, and Vikery auction.

19. The method of claim 17 further comprising constructing at least one estimate of the suitability of the intellectual property holding bid to the intellectual property holding offer by predicting at least one value of the match to the first generalized actor and the second generalized actor by the additional steps of:
b) obtaining data from similar or equivalent bids and offers by data mining at least one set of data selected from the group consisting of:
historical transactions, financial records, polling of expert opinion, securities and exchange commission data, USPTO data, equities data, options data, and futures data;
c) constructing a prediction of the value of the match via at least one method of estimation selected from the group consisting of:
AdaBoost, artificial neural networks, auto-regressive integrated moving averages, bagging, Bayesian analysis clustering, Bayesian influence networks, boosting, C4.5, C5.0, Chi-square automatic interaction detection, clustering by expectation, competitive learning, constrained association rule approaches, density-based clustering, deviation-based outlier detection, distance-based outlier detection, error minimization via robust optimization, frequent-pattern tree approaches, generalization-tree approaches, generalized autoregressive conditional heteroskedastic methods, hidden-Markov models, hierarchical learning, hypergraph partitioning algorithms, ID3, incremental conceptual clustering, inductive logic programming, inferred rules, Kalman filtering, kernel methods, k-means clustering, k-medoids clustering, latent semantic indexing, linear regression, Logit regression, multi-resolution grid clustering, non-linear regression, one-R, principal component analysis, radial basis functions, regression tree approaches, robust clustering using links, rough-set classifiers, Self-organizing maps, stacking, support vector machines, the direct hashing and pruning algorithm, the dynamic itemset counting algorithm, time-series learning, unsupervised learning, vertical itemset partitioning algorithms, vertical-layout algorithms, Voronoi diagrams, wagging, wavelets, and zero-R.

20. The method of claim 17 further comprising constructing at least one estimate of the intellectual property holding offer context or the intellectual property holding bid context to by the additional steps of :
d) obtaining data about the bidder or offeror or similar or equivalent entities by data mining at least one set of data selected from the group consisting of:
company descriptions, historical transactions, financial records, polling of expert opinion, securities and exchange commission data, USPTO data, equities data, options data, and futures data;
e) constructing a prediction of the context of the bidder or the offeror via at least one method of estimation selected from the group consisting of:
AdaBoost, artificial neural networks, auto-regressive integrated moving averages, bagging, Bayesian analysis clustering, Bayesian influence networks, boosting, C4.5, C5.0, Chi-square automatic interaction detection, clustering by expectation, competitive learning, constrained association rule approaches, density-based clustering, deviation-based outlier detection, distance-based outlier detection, error minimization via robust optimization, frequent-pattern tree approaches, generalization-tree approaches, generalized autoregressive conditional heteroskedastic methods, hidden-Markov models, hierarchical learning, hypergraph partitioning algorithms, ID3, incremental conceptual clustering, inductive logic programming, inferred rules, Kalman filtering, kernel methods, k-means clustering, k-medoids clustering, latent semantic indexing, linear regression, Logit regression, multi-resolution grid clustering, non-linear regression, one-R, principal component analysis, radial basis functions, regression tree approaches, robust clustering using links, rough-set classifiers, Self-organizing maps, stacking, support vector machines, the direct hashing and pruning algorithm, the dynamic itemset counting algorithm, time-series learning, unsupervised learning, vertical itemset partitioning algorithms, vertical-layout algorithms, Voronoi diagrams, wagging, wavelets, and zero-R.

21. The method of claim 17, further comprising distributing by predicting at least one value of the match or at least one estimate of the intellectual property holding offer context or the intellectual property holding bid context by distributing the computation over multiple processors, using at least one multiprocessor computation method selected from the group consisting of:
symmetric multiprocessing (SMP), asymmetrical multiprocessing (ASMP), Non-Uniform Memory Access(NUMA) computing, Massive parallel processing (MPP), multi-core processing, cluster computing, grid computing, and cloud computing.

22. A computer implemented data processing system providing an intellectual property pre-market among generalized actors comprising:
f) one or more processors or virtual machines;
g) one or more memory units;
h) one or more input devices and one or more output devices;
i) optionally a network;
j) optionally shared memory supporting communication among the processors;
k) a means for obtaining at least one intellectual property holding offer from at least one first generalized actor;
l) a means for obtaining at least one intellectual property holding offer context from the first generalized actor;
m) a means for obtaining at least one intellectual property description from at least one second generalized actor;
n) a means for providing the intellectual property description to potential intellectual property holding bidders;
o) a means for obtaining at least one intellectual property holding bid from the at least one third generalized actor;
p) a means for obtaining at least one intellectual property holding bid context from the third generalized actor;
q) a means for using the intellectual property description to match the intellectual property holding bid to the intellectual property holding offer; and
r) constructing a set of intellectual property transfer term relating to the intellectual property holding, the intellectual property holding offer, and the intellectual property holding bid;
s) obtaining a commitment to the intellectual property transfer term from the first generalized actor;
t) obtaining a commitment to the intellectual property transfer term from the third generalized actor; and
u) a means for performing a transaction between the first generalized actor and the third generalized actor.

23. A computer-readable medium having computer-executable instructions for providing an intellectual property pre-market among generalized actors wherein the computer-executable instructions comprise the means of claim 22.

24. The computer program product of claim 22, further comprising: computer readable code providing interaction with the software that intellectual property pre-market.
